(19) United States
(12) Patent Application Publication
(10) Pub. No.: US 2021/0229129 A1
(43) Pub. Date: Jul. 29, 2021

(54) FORMATION SHEET, FORMATION SHEET MANUFACTURING METHOD, AND SHAPED OBJECT

(71) Applicant: CASIO COMPUTER CO., LTD., Tokyo (JP)

(72) Inventor: Yoshimune MOTOYANAGI, Tokyo (JP)

(73) Assignee: CASIO COMPUTER CO., LTD., Tokyo (JP)

(21) Appl. No.: 17/158,491

(22) Filed: Jan. 26, 2021

(30) Foreign Application Priority Data
Jan. 29, 2020 (JP) 2020-012163

(51) Int. Cl. B05D 7/00; B41M 1/12

(52) U.S. Cl. CPC B05D 7/546; B41M 1/12

(57) ABSTRACT

A formation sheet is equipped with (i) a base, and (ii) n thermal expansion layers (n is greater than or equal to two) stacked on a first main surface of the base and each including a binder and a thermal expansion material that expands due to heat. Among post-expansion average particle sizes of the thermal expansion materials included in the n thermal expansion layers, a post-expansion average particle size of the thermal expansion material included in an n-th thermal expansion layer is smallest.

### CROSS-REFERENCE TO RELATED APPLICATION

This application claims the benefit of Japanese Patent Application No. 2020-012163, filed on Jan. 29, 2020, the entire disclosure of which is incorporated by reference herein.

### FIELD

This application relates to a formation sheet, a formation sheet manufacturing method, and a shaped object.

### BACKGROUND

Technology is known for manufacture of a sheet forming a three-dimensional image, that is, a shaped object, by performing photoirradiation onto a thermal expansive sheet forming an image and selectively heating an image portion (for example, Examined Japanese Patent Application Publication No. S59-35359).

### SUMMARY

A formation sheet according to a first aspect of the present disclosure includes:

a base; and

n thermal expansion layers that each include a binder and a thermal expansion material that expands due to heat, the thermal expansion layers being stacked on a first main surface of the base, n being an integer greater than or equal to two.

Among post-expansion average particle sizes of the thermal expansion material included in each of the n thermal expansion layers, a post-expansion average particle size of the thermal expansion material included in an n-th thermal expansion layer is smallest.

A manufacturing method of a formation sheet according to a second aspect of the present disclosure includes:

a first layer stacking step of stacking, on a first main surface of a base, an (n−1)-th thermal expansion layer among n thermal expansion layers stacked on the first main surface of the base, the n thermal expansion layers that each include a binder and a thermal expansion material that expands due to heat, n being an integer greater than or equal to two; and

a second layer stacking step of stacking an n-th thermal expansion layer on the (n−1)-th thermal expansion layer.

Among post-expansion average particle sizes of the thermal expansion material included in each of the n thermal expansion layers, a post-expansion average particle size of the thermal expansion material included in the n-th thermal expansion layer is smallest.

A shaped object according to a third aspect of the present disclosure includes:

a base; and

n expanded thermal expansion layers that each include a binder and an expanded thermal expansion material, the expanded thermal expansion layers being stacked on a first main surface of the base, n being an integer greater than or equal to two, the expanded thermal expansion layers that each have unevennesses on a surface opposing the base.

Among average particle sizes of the expanded thermal material included in each of the n expanded thermal expansion layers, an average particle size of the expanded thermal expansion material included in an n-th expanded thermal expansion layer is smallest.

### BRIEF DESCRIPTION OF THE DRAWINGS

A more complete understanding of this application can be obtained when the following detailed description is considered in conjunction with the following drawings, in which:

FIG. 1 is a schematic drawing illustrating a cross section of a formation sheet according to Embodiment 1;

FIG. 2 is a flowchart illustrating a manufacturing method for the formation sheet according to Embodiment 1;

FIG. 3 is a perspective view of a shaped object according to Embodiment 1;

FIG. 4 is a cross sectional drawing taken along line A-A of the shaped object illustrated in FIG. 3;

FIG. 5 is a schematic drawing for description of smoothness of a surface of the shaped object according to Embodiment 1;

FIG. 6 is a flowchart illustrating a manufacturing method of the shaped object according to Embodiment 1;

FIG. 7 is a schematic drawing illustrating a cross section of a formation sheet having thermal conversion layers stacked thereon according to Embodiment 1;

FIG. 8 is a schematic drawing illustrating a cross section of a formation sheet according to Embodiment 2;

FIG. 9 is a flowchart illustrating a manufacturing method of the formation sheet according to Embodiment 2; and

FIG. 10 is a schematic drawing illustrating a cross section of a shaped object according to Embodiment 2.

### DETAILED DESCRIPTION

A formation sheet according to an embodiment is described below with reference to drawings.

### Embodiment 1

A formation sheet 10 of the present embodiment is used for manufacturing a shaped object 100. The shaped object 100 of the present embodiment is used as a decorated sheet, a wallpaper, or the like. In the present disclosure, a “shaped object” is a sheet having unevennesses shaped (formed) on a certain surface, and the “unevennesses” include geometric shapes, characters, patterns, decorations, or the like. The term “decoration” refers to an object that appeals to the aesthetic sense of a person through visual and/or tactile sensation. The term “to shape (or to form)” refers to creating an object having a shape and also encompasses the concepts of adding decorations and forming decorations. Although the shaped object 100 according to the present embodiment is a three-dimensional object having unevennesses on a certain surface, to distinguish this three-dimensional object from a three-dimensional object fabricated by a so-called 3D printer, the shaped object 100 of the present embodiment is also called a 2.5-dimensional (2.5D) object or a pseudo-three-dimensional (pseudo-3D) object. The technique for fabricating the shaped object 100 according to the present embodiment is also called a 2.5D printing technique or a pseudo-3D printing technique.

Formation Sheet

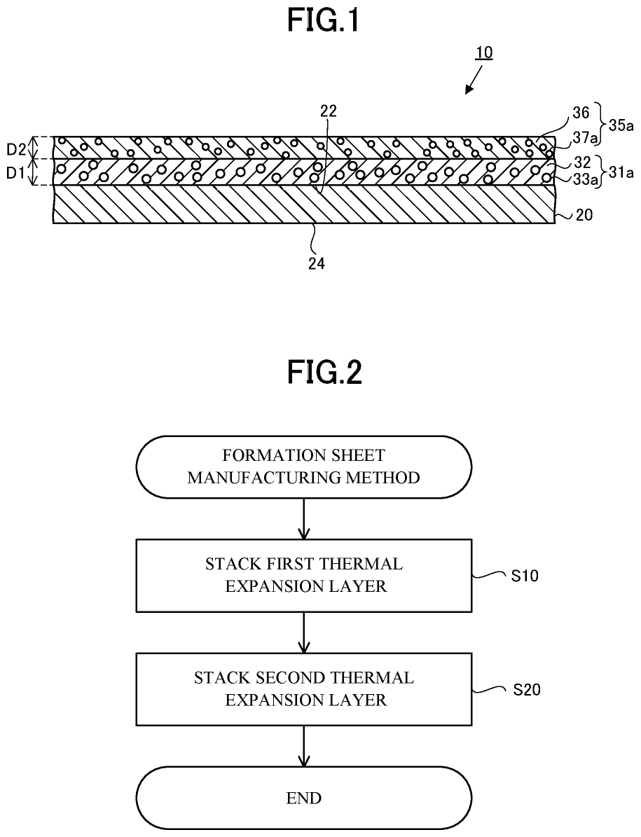

The formation sheet 10 is described below with reference to FIG. 1. As illustrated in FIG. 1, the formation sheet 10 includes (i) a base 20, and (ii) two thermal expansion layers stacked on a first main surface 22 of the base 20, that is, a first thermal expansion layer 31a and a second thermal expansion layer 35a. In the present embodiment, the first thermal expansion layer 31a and the second thermal expansion layer 35a are stacked on the entirety of the first main surface 22.

The base 20 of the formation sheet 10 has (i) the first main surface 22 on which are stacked the first thermal expansion layer 31a and the second thermal expansion layer 35a, and (ii) a second main surface 24 opposite to the first main surface 22. The base 20 supports the first thermal expansion layer 31a and the second thermal expansion layer 35a. The base 20 is formed in a sheet-like shape, for example. Examples of materials included in the base 20 include thermoplastic resins, such as polyolefin resins (for example, polyethylene (PE) and polypropylene (PP)) and polyester resins (for example, polyethylene terephthalate (PET) and polybutylene terephthalate (PBT)). The type of the material included in the base 20 and the thickness of the base 20 are selected according to the application of the shaped object 100.

The first thermal expansion layer 31a of the formation sheet 10 expands to form an expanded first thermal expansion layer 31b. Moreover, the second thermal expansion layer 35a of the formation sheet 10 expands to form the expanded second thermal expansion layer 35b. By formation of the expanded first thermal expansion layer 31b and the second thermal expansion layer 35b, below-described unevennesses 110 of the shaped object 100 are formed.

The first thermal expansion layer 31a of the formation sheet 10 is stacked on the first main surface 22 of the base 20. The first thermal expansion layer 31a includes (i) a first binder 32, and (ii) a first thermal expansion material 33a, that is, a pre-expansion first thermal expansion material, dispersed in the first binder 32. The first binder 32 is a freely selected thermoplastic resin such as a vinyl acetate type polymer, an acrylate type polymer, or the like. By undergoing heating at a temperature greater than or equal to a prescribed temperature such as 80° C., the first thermal expansion material 33a expands to a size in accordance with the amount of heat (specifically, depending on a heating temperature or heating period, for example) to form a below-described expanded first thermal expansion material 33b. By formation of the expanded first thermal expansion material 33b, the first thermal expansion layer 31a expands to form the expanded first thermal expansion layer 31b.

The first thermal expansion material 33a, for example, is a thermally expandable microcapsule. Such thermally expandable microcapsules are microcapsules formed by enclosing a foaming agent including a low boiling point substance, such as propane or butane, in a thermoplastic resin shell. The shell of the thermally expandable microcapsule is formed from thermoplastic resins such as polystyrene, polyvinyl chloride, polyvinylidene chloride, polyvinyl acetate, polyacrylic acid ester, polyacrylonitrile, polybutadiene, and copolymers thereof. Heating of the thermally expandable microcapsule to a temperature greater than or equal to a prescribed temperature causes softening of the shell and evaporation of the foaming agent. Due to the pressure of the evaporated foaming agent, the shell expands in a balloon-like manner. The thermally expandable microcapsule expands to a particle size approximately five times larger than the particle size of the unexpanded microcapsule. The average particle size of the unexpanded thermally expandable microcapsules is 5 μm to 50 μm, for example.

The second thermal expansion layer 35a of the formation sheet 10 is stacked on the first thermal expansion layer 31a. The second thermal expansion layer 35a includes (i) a second binder 36 and (ii) a second thermal expansion material 37a, that is, the second thermal expansion material prior to expansion, dispersed in the second binder 36. Like the first binder 32, the second binder 36 is a freely selected thermoplastic resin such as a vinyl acetate type polymer, an acrylate type polymer, or the like. By undergoing heating at a temperature greater than or equal to a prescribed temperature, the second thermal expansion material 37a expands to a size in accordance with the amount of heat to form a below-described expanded second thermal expansion material 37b. By formation of the expanded second thermal expansion material 37b, the second thermal expansion layer 35a expands to form the expanded second thermal expansion layer 35b. The second thermal expansion material 37a, for example, is a thermally expandable microcapsule.

In the present embodiment, average particle size after expansion for the second thermal expansion material 37a included in the second thermal expansion layer 35a located uppermost (that is, the average particle size of the expanded second thermal expansion material 37b) is smaller than the average particle size after expansion for the first thermal expansion material 33a (that is, the average particle size of the expanded first thermal expansion material 33b). Therefore, unevennesses of the surface of the shaped object 100 occurring due to the expanded second thermal expansion material 37b are decreased, thereby enabling achievement of high smoothness of the surface of the shaped object 100. Moreover, the expanded second thermal expansion layer 35b including the expanded second thermal expansion material 37b having the small average particle size buries the large unevennesses of the surface of the expanded first thermal expansion layer 31b that occur due to the expanded first thermal expansion material 33b having the large average particle size, thereby enabling achievement of higher smoothness of the surface of the shaped object 100. Smoothness of the surface of the shaped object 100 is described below.

Moreover, the pre-expansion average particle size of the second thermal expansion material 37a is preferably smaller than the pre-expansion average particle size of the thermal expansion material 33a. Such configuration enables the average particle size of the expanded second thermal expansion material 37b to be easily made smaller than the average particle size of the expanded first thermal expansion material 33b. Furthermore, a thickness D2 of the second thermal expansion layer 35a is preferably less than a thickness D1 of the first thermal expansion layer 31a. Such configuration enables increasing of the thickness D1 of the first thermal expansion layer 31a that includes the first thermal expansion material 33a that has the large post-expansion average particle size, thereby enabling increase in the height of the unevennesses 110 of the shaped object 100.

Next, the manufacturing method of the formation sheet 10 is described. FIG. 2 is a flowchart illustrating the manufacturing method of the formation sheet 10. The manufacturing method of the formation sheet 10 includes: (i) a first layer stacking step of stacking upon the first main surface 22 of the base 20 the first thermal expansion layer 31a that includes the first binder 32 and the first thermal expansion material 33a (step S10), and (ii) a second layer stacking step of stacking upon the first thermal expansion layer 31a the second thermal expansion layer 35a that includes the second binder 36 and the second thermal expansion material 37a (step S20). In this manner, the post-expansion average particle size of the second thermal expansion material 37a is smaller than the post-expansion average particle size of the first thermal expansion material 33a.

Firstly, the base 20, a first coating solution for forming the first thermal expansion layer 31a, and a second coating solution for forming the second thermal expansion layer 35a are prepared. The base 20, for example, is a PET sheet of A4 paper size. The first coating solution is formulated by mixing the first binder 32 and the first thermal expansion material 33a. The second coating solution is formulated by mixing the second binder 36 and the second thermal expansion material 37a.

In the first layer stacking step (step S10), a coating device is used to coat the first coating solution on the first main surface 22 of the base 20. The coating device, for example, is a screen printer. Thereafter, the first coating solution coated onto the first main surface 22 of the base 20 is dried. Such processing stacks the first thermal expansion layer 31a on the first main surface 22 of the base 20. The coating and drying of the first coating solution may be repeated in order to obtain a prescribed thickness of the first thermal expansion layer 31a.

In the second layer stacking step (step S20), the coating device is used to coat the second coating solution on the first thermal expansion layer 31a. Then the coated second coating solution is dried. Due to such processing, the second thermal expansion layer 35a is stacked on the first thermal expansion layer 31a. Like the first thermal expansion layer 31a, the coating and drying of the second coating solution may be repeated in order to obtain a prescribed thickness of the second thermal expansion layer 35a. Such processing enables production of the formation sheet 10.

Shaped Object

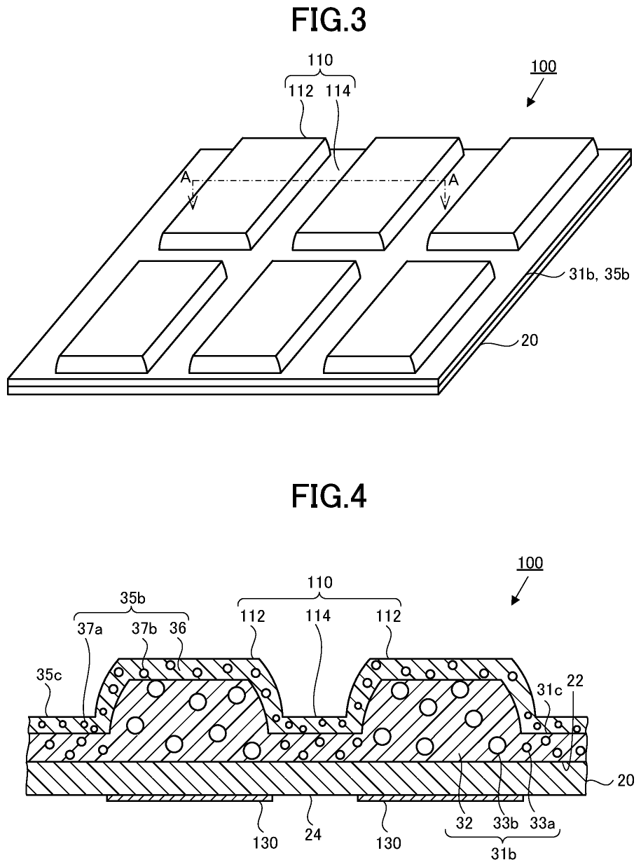

The shaped object 100 is described next with reference to FIGS. 3 to 7. As illustrated in FIGS. 3 and 4, the shaped object 100 is equipped with (i) the base 20 and (ii) two expanded thermal expansion layers, that is, the expanded first thermal expansion layer 31b and the expanded second thermal expansion layer 35b, stacked on the first main surface 22 of the base 20. The shaped object 100 is further equipped with a thermal conversion layer 130 stacked on the second main surface 24 of the base 20. The expanded first thermal expansion layer 31b has unevennesses on a surface 31c opposite to the base 20. Moreover, the expanded second thermal expansion layer 35b has unevennesses on a surface 35c opposite to the base 20.

The shaped object 100 is a sheet-like shaped object. The shaped object 100 has the unevennesses 110 on the surface thereof. The unevennesses 110 include protrusions 112 and recesses 114. The composition of the base 20 of the shaped object 100 is similar to that of the base 20 of the formation sheet 10, and thus the expanded first thermal expansion layer 31b, the expanded second thermal expansion layer 35b, and the thermal conversion layer 130 are described hereinafter.

The expanded first thermal expansion layer 31b is a layer obtained by expanding a portion of the first thermal expansion layer 31a of the formation sheet 10. The expanded first thermal expansion layer 31b includes the first binder 32, the first thermal expansion material 33a, and the expanded first thermal expansion material 33b. The first binder 32 and the first thermal expansion material 33a of the expanded first thermal expansion layer 31b are similar to the first binder 32 and the first thermal expansion material 33a of the first thermal expansion layer 31a. The expanded first thermal expansion material 33b is thermal expansion material that is expanded by heating the first thermal expansion material 33a of the first thermal expansion layer 31a to a temperature greater than or equal to a prescribed temperature. The unevennesses of the expanded first thermal expansion layer 31b include (i) protrusions that include the expanded first thermal expansion material 33b and (ii) recesses that include the first thermal expansion material 33a.

The expanded second thermal expansion layer 35b is a layer obtained by expanding a portion of the second thermal expansion layer 35a of the formation sheet 10. The expanded second thermal expansion layer 35b includes the second binder 36, the second thermal expansion material 37a, and the expanded second thermal expansion material 37b. The second binder 36 and the second thermal expansion material 37a of the expanded second thermal expansion layer 35b are similar to the second binder 36 and the second thermal expansion material 37a of the second thermal expansion layer 35a. The expanded second thermal expansion material 37b is thermal expansion material that is expanded by heating the second thermal expansion material 37a of the second thermal expansion layer 35a to a temperature greater than or equal to a prescribed temperature. The unevennesses of the expanded second thermal expansion layer 35b include (i) protrusions that include the expanded second thermal expansion material 37b and (ii) recesses that include the second thermal expansion material 37a.

In the present embodiment, the protrusions 112 of the shaped object 100 include the protrusions of the expanded second thermal expansion layer 35b and the protrusions of the expanded first thermal expansion layer 31b. Moreover, the recesses 114 of the shaped object 100 include the recesses of the expanded second thermal expansion layer 35b and the recesses of the expanded first expansion layer 31b.

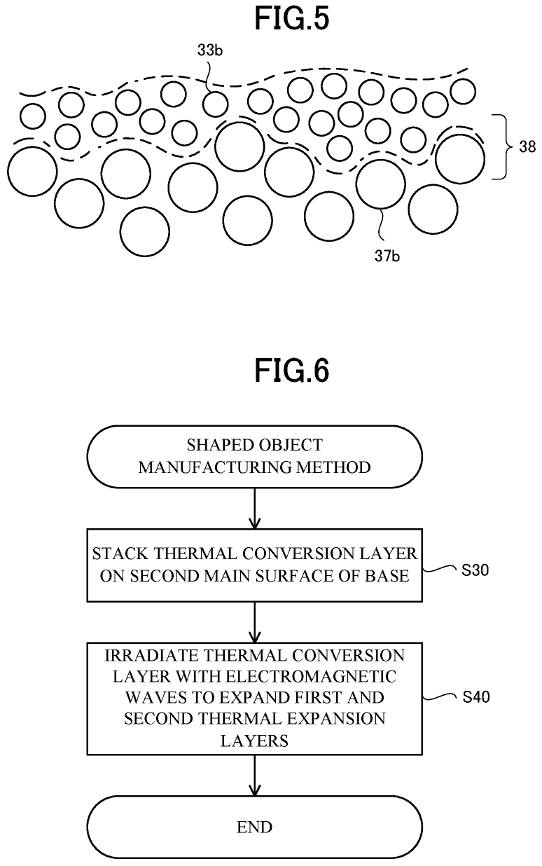

In the present embodiment, the average particle size of the expanded second thermal expansion material 37b included in the expanded second thermal expansion layer 35b that is located most upwardly is smaller than the average particle size of the expanded first thermal expansion material 33b. Therefore, the unevennesses of the surface of the shaped object 100 that occur due to the expanded second thermal expansion material 37b are made small, thereby enabling achievement of high smoothness of the surface of the shaped object 100. Further, at a boundary 38 between the expanded first thermal expansion layer 31b and the expanded second thermal expansion layer 35b of the protrusions 112 of the shaped object 100 as illustrated in FIG. 5, the second thermal expansion layer 35b including the expanded second thermal expansion material 37b of small average particle size buries the large unevennesses of the surface of the expanded first thermal expansion layer 31b that occur due to the expanded first thermal expansion material 33b of large average particle size. Thus, unevennesses become small for the surface of the expanded second thermal expansion layer 35b that is the uppermost layer including the expanded second thermal expansion material 37b of small average particle size, and smoothness of the surface of the shaped object 100 can be further improved.

The average particle size of the expanded second thermal expansion material 37b is preferably one half or less of the average particle size of the expanded first thermal expansion material 33b, and is further preferably one third or less of the average particle size of the expanded first thermal expansion material 33b. Due to such configuration, the expanded second thermal expansion layer 35b easily buries the unevennesses of the surface of the expanded first thermal expansion layer 31b, thereby enabling achievement of higher smoothness of the surface of the shaped object 100.

The thermal conversion layer 130 of the shaped object 100 is arranged for forming the unevennesses 110. The thermal conversion layer 130 is stacked, on the second main surface 24 of the base 20, in a certain pattern that corresponds to the unevennesses 110 of the shaped object 100.

The thermal conversion layer 130 converts emitted electromagnetic waves into heat and releases the converted heat. Due to such operation, the first thermal expansion layer 31a and the second thermal expansion layer 35a of the formation sheet 10 are heated to a prescribed temperature. The temperature of the heated first thermal expansion layer 31a and the heated second thermal expansion layer 35a can be controlled by (i) a dispersion state (that is, a density or concentration of the thermal conversion material) of the thermal conversion layer 130 including the below-described thermal conversion material and (ii) the amount of energy of the electromagnetic waves emitted to the thermal conversion layer 130 per unit area and unit time. The thermal conversion layer 130 converts electromagnetic waves into heat at a rate higher in comparison to the other portions of the formation sheet 10, leading to selective heating of the first thermal expansion layer 31a and the second thermal expansion layer 35a adjacent to the thermal conversion layer 130.

The thermal conversion layer 130 includes a thermal conversion material for converting absorbed electromagnetic waves into heat. Examples of the thermal conversion material include carbon blacks, metal hexaboride compounds, and tungsten oxide compounds. The carbon blacks can absorb electromagnetic waves, such as visible light and infrared light, and convert the electromagnetic waves into heat, for example. The metal hexaboride compounds and the tungsten oxide compounds can absorb near-infrared light and convert the light into heat. Among the metal hexaboride compounds and the tungsten oxide compounds, lanthanum hexaboride (LaB₆) and cesium tungsten oxide are preferred due to high absorbance in the near-infrared range and high transmittance in the visible light range.

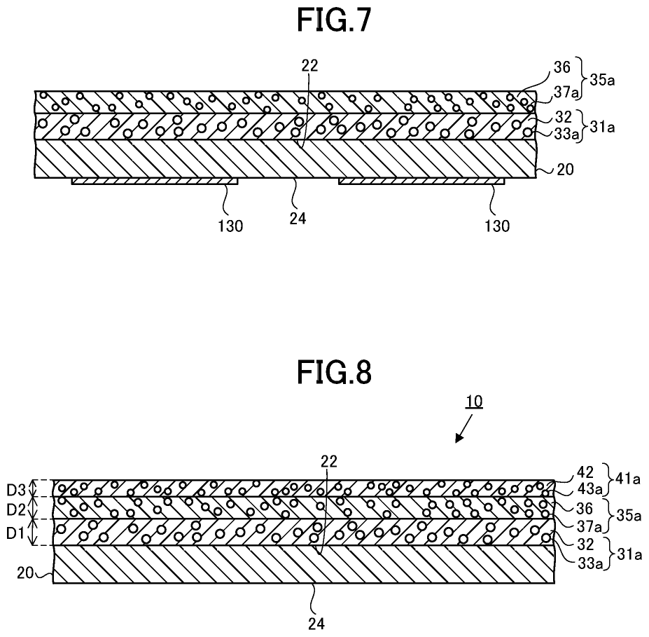

The manufacturing method of the shaped object 100 is described below with reference to FIGS. 6 and 7. In the present embodiment, the shaped object 100 is manufactured from the sheet-like formation sheet 10 that is of A4 paper size, for example.

FIG. 6 is a flowchart illustrating the manufacturing method of the shaped object 100. The manufacturing method of the shaped object 100 includes (i) a thermal conversion layer lamination step of stacking the thermal conversion layer 130 on the second main surface 24 of the base 20 of the formation sheet 10 (step S30) and (ii) an expansion step of using electromagnetic wave to irradiate the thermal conversion layer 130 to cause expansion of the first thermal expansion layer 31a and the second thermal expansion layer 35a of the formation sheet 10 (step S40).

In the thermal conversion layer lamination step (step S30), firstly the formation sheet 10 and an ink that includes the thermal conversion material are prepared. The formation sheet 10 is manufactured, for example, by the above-described manufacturing method of the formation sheet 10 (step S10 and step S20). The ink that includes the thermal conversion material, for example, is an ink that includes LaB₆.

Next, a printer prints, on the second main surface 24 of the base 20 of the formation sheet 10, the ink including the thermal conversion material to form a pattern corresponding to the unevennesses 110 of the shaped object 100. Due to such operation, the thermal conversion layer 130 is stacked on the second main surface 24 as illustrated in FIG. 7. The printer, for example, is an inkjet printer.

In the expansion step (step S40), the thermal conversion layer 130 is irradiated using electromagnetic waves to cause the generation of heat in the thermal conversion layer 130. Due to the heat generated in the thermal conversion layer 130, the first thermal expansion layer 31a and the second thermal expansion layer 35a are heated, thereby causing expansion of the first thermal expansion layer 31a and the second thermal expansion layer 35a.

Specifically, an unillustrated irradiation device is used to irradiate the conversion layer 130 stacked on the second main surface 24 of the base 20 with electromagnetic waves that are absorbed and converted to heat by the thermal conversion layer 130. The irradiation device, for example, is equipped with a halogen lamp and emits electromagnetic waves in the near-infrared range (wavelength of 750 to 1,400 nm), the visible light range (wavelength of 380 to 750 nm), the mid-infrared range (wavelength of 1,400 to 4,000 nm), or the like. Due to such operation, the first thermal expansion material 33a of the first thermal expansion layer 31a and the second thermal expansion material 37a of the second thermal expansion layer 35a expand due to the heat generated in the thermal conversion layer 130, thereby forming the expanded first thermal expansion material 33b and the expanded second thermal expansion material 37b. Further, the first thermal expansion layer 31a and the second thermal expansion layer 35a expand, thereby forming the expanded first thermal expansion layer 31b and the expanded second thermal expansion layer 35b. The unevennesses 110 are formed by such operation. The shaped object 100 can be manufactured by the above-described processing.

In the above-described manner, the average particle size of the expanded second thermal expansion material 37b included in the expanded second thermal expansion layer 35b that is located uppermost (post-expansion average particle size of the second thermal expansion material 37a) is smaller than the average particle size of the expanded first thermal expansion material 33b (post-expansion average particle size of the first thermal expansion material 33a), and thus smoothness of the surface of the shaped object 100 can be heightened.

### Embodiment 2

The formation sheet 10 in Embodiment 1 is equipped with two expansion layers, that is, the first thermal expansion layer 31a and the second thermal expansion layer 35a; and the shaped object 100 is equipped with two expanded thermal expansion layers, that is the expanded first thermal expansion layer 31b and the expanded second thermal expansion layer 35b. The number of the thermal expansion layers is not limited to that of such configuration. In the present embodiment, the formation sheet 10 is equipped with three thermal expansion layers, and the shaped object 100 is equipped with three expanded thermal expansion layers.

Formation Sheet

As illustrated in FIG. 8, the formation sheet 10 of the present embodiment is equipped with the base 20, the first thermal expansion layer 31a, the second thermal expansion layer 35a, and a third thermal expansion layer 41a. The first thermal expansion layer 31a, the second thermal expansion layer 35a, and the third thermal expansion layer 41a are stacked on the first main surface 22 of the base 20. The configurations of the base 20, the first thermal expansion layer 31a and the second thermal expansion layer 35a of the present embodiment are similar to the configurations of the base 20, the first thermal expansion layer 31a, and the second thermal expansion layer 35a of Embodiment 1, and thus the third thermal expansion layer 41a is described here. Further, the first thermal expansion layer 31a, the second thermal expansion layer 35a, the third thermal expansion layer 41a, or the like below are sometimes referred to collectively as the “thermal expansion layer”. Moreover, the first thermal expansion material 33a, the second thermal expansion material 37a, a third thermal expansion material 43a, or the like are sometimes referred to collectively as the “thermal expansion material”.

The third thermal expansion layer 41a is stacked on the second thermal expansion layer 35a. The third thermal expansion layer 41a includes (i) a third binder 42 and (ii) a third thermal expansion material 43a, that is, a pre-expansion third thermal expansion material, dispersed in the third binder 42. The third binder 42, similarly to the first binder 32 and the second binder 36, is a freely selected thermoplastic resin such as a vinyl acetate type polymer, an acrylate type polymer, or the like. The third thermal expansion material 43a, for example, is a thermally expandable microcapsule.

By undergoing heating at a temperature greater than or equal to a prescribed temperature, the third thermal expansion material 43a expands to form a below-described expanded third thermal expansion material 43b. By formation of the expanded third thermal expansion material 43b, the third thermal expansion layer 41a expands to form the expanded third thermal expansion layer 41b. In the present embodiment, the post-expansion average particle size of the third thermal expansion material 43a, that is, the average particle size of the expanded third thermal expansion material 43b, is smaller than the post-expansion average particle size of the second thermal expansion material 37a. That is, among the first thermal expansion material 33a, the second thermal expansion material 37a, and the third thermal expansion material 43a, the post-expansion average particle size of the third thermal expansion material 43a is smallest, and the post-expansion average particle size of the thermal expansion material becomes smaller in order from the base 20 side.

In the present embodiment, the post-expansion average particle size of the third thermal expansion material 43a included in the third thermal expansion layer 41a located most upwardly is smaller than the post-expansion average particle size of the second thermal expansion material 37a. Therefore, unevennesses of the surface of the shaped object 100 occurring due to the expanded second thermal expansion material 37b can be made small, thereby enabling achievement of high smoothness of the surface of the shaped object 100. Furthermore, similarly to Embodiment 1, the post-expansion average particle size of the second thermal expansion material 37a is smaller than the post-expansion average particle size of the first thermal expansion material 33a. Therefore, the expanded second thermal expansion layer 35b that includes the expanded second thermal expansion material 37b of small average particle size buries the large unevennesses of the surface of the expanded first thermal expansion layer 31b. Further, an expanded third thermal expansion layer 41b that includes the expanded third thermal expansion material 43b located most upwardly and having smallest average particle size buries the unevennesses of the surface of the expanded second thermal expansion layer 35b, thereby enabling achievement of higher smoothness of the surface of the shaped object 100.

Furthermore, the pre-expansion average particle size of the third thermal expansion material 43a is preferably smaller than the pre-expansion average particle size of the second thermal expansion material 37a; that is, among the first thermal expansion material 33a, the second thermal expansion material 37a, and the third thermal expansion material 43a, the pre-expansion average particle size of the third thermal expansion material 43a is preferably smallest. Due to such configuration, the average particle size of the expanded third thermal expansion material 43b can be easily made smaller than the average particle size of the expanded second thermal expansion material 37b. Furthermore, a thickness D3 of the third thermal expansion layer 41a is preferably less than the thickness D2 of the second thermal expansion layer 35a and the thickness D1 of the first thermal expansion layer 31a. Due to such configuration, the thickness D2 of the second thermal expansion layer 35a and the thickness D1 of the first thermal expansion layer 31a can be made high, thereby enabling achievement of high heights of the unevennesses 110 of the shaped object 100.

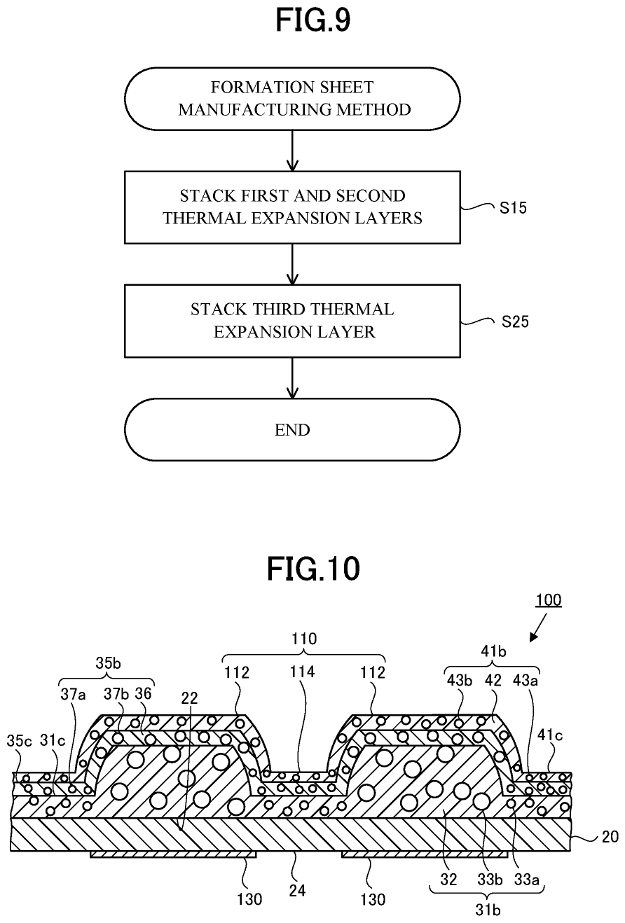

Next, the manufacturing method of the formation sheet 10 of the present embodiment is described. FIG. 9 is a flowchart illustrating the manufacturing method of the formation sheet 10 of the present embodiment. The manufacturing method of the formation sheet 10 of the present embodiment includes (i) a first layer stacking step of stacking on the first main surface 22 of the base 20 the first thermal expansion layer 31a including the first binder 32 and the first thermal expansion material 33a and the second thermal expansion layer 35a including the second binder 36 and the second thermal expansion material 37a (step S15), and (ii) a second layer stacking step of stacking on the second thermal expansion layer 35a the third thermal expansion layer 41a that includes the third binder 42 and the third thermal expansion material 43a (step S25). The post-expansion average particle size of the second thermal expansion material 37a is smaller than the post-expansion average particle size of the first thermal expansion material 33a. Moreover, the post-expansion average particle size of the third thermal expansion material 43a is smaller than the post-expansion average particle size of the second thermal expansion material 37a.

Firstly similarly to Embodiment 1, the base 20, a first coating solution for forming the first thermal expansion layer 31a, and a second coating solution for forming the second thermal expansion layer 35a are prepared. Moreover, a third coating solution for forming the third thermal expansion layer 41a is prepared. The third coating solution is formulated by mixing the third binder 42 and the third thermal expansion material 43a.

In the first layer stacking step (step S15), the first coating solution is coated on the first main surface 22 of the base 20 similarly to Embodiment 1. Then the coated first coating solution is dried. Further, the second coating solution is coated on the first thermal expansion layer 31a. Then the coated second coating solution dried. Due to such processing, the first thermal expansion layer 31a and the second thermal expansion layer 35a are stacked on the first main surface 22 of the base 20.

In the second layer stacking step (step S25), the coating device is used to coat the third coating solution on the second thermal expansion layer 35a. Next, the coated third coating solution dried. Due to such processing, the third thermal expansion layer 41a is stacked on the second thermal expansion layer 35a. Such processing enables the manufacture of the formation sheet 10 of the present embodiment.

Shaped Object

Next, the shaped object 100 of the present embodiment is described. As illustrated in FIG. 10, the shaped object 100 of the present embodiment is equipped with the base 20, the expanded first thermal expansion layer 31b, the expanded second thermal expansion layer 35b, the expanded third thermal expansion layer 41b, and the thermal conversion layer 130 that is stacked on the second main surface 24 of the base 20. The expanded first thermal expansion layer 31b, the expanded second thermal expansion layer 35b, and the expanded third thermal expansion layer 41b are stacked on the first main surface 22 of the base 20.

The shaped object 100 of the present embodiment has the unevennesses 110 on the surface, similarly to the shaped object 100 of Embodiment 1. Moreover, the unevennesses 110 include the protrusions 112 and the recesses 114. The configurations of the base 20, the expanded first thermal expansion layer 31b, the expanded second thermal expansion layer 35b, and the thermal conversion layer 130 of the present embodiment are similar to those of Embodiment 1, and thus the expanded third thermal expansion layer 41b is described below.

The expanded third thermal expansion layer 41b is a layer obtained by expanding a portion of the third thermal expansion layer 41a of the formation sheet 10. The expanded third thermal expansion layer 41b has unevennesses on a surface 41c that is opposite to the base 20. In the present embodiment, the protrusions 112 of the shaped object 100 include the protrusions of the expanded third thermal expansion layer 41b, the expanded second thermal expansion layer 35b, and the expanded first thermal expansion layer 31b. Moreover, the recesses 114 of the shaped object 100 include the recesses of the expanded third thermal expansion layer 41b, the expanded second thermal expansion layer 35b, and the expanded first thermal expansion layer 31b.

The expanded third thermal expansion layer 41b includes the third binder 42, the third thermal expansion material 43a, and the expanded third thermal expansion material 43b. The third binder 42 and the third thermal expansion material 43a are similar to the first binder 32 and the third thermal expansion material 43a of the third thermal expansion layer 41a. The expanded third thermal expansion material 43b is thermal expansion material that is expanded by heating the third thermal expansion material 43a of the third thermal expansion layer 41a to a temperature greater than or equal to a prescribed temperature. In the aforementioned manner, the average particle size of the expanded third thermal expansion material 43b is smaller than the average particle size of the expanded second thermal expansion material 37b. The post-expansion average particle size of the thermal expansion material is smaller in order from the base 20 side.

In the present embodiment, the average particle size of the expanded thermal expansion material is smaller in order from the base 20 side. That is, among the expanded first thermal expansion material 33b, the expanded second thermal expansion material 37b, and the expanded third thermal expansion material 43b, the average particle size of the expanded third thermal expansion material 43b is smallest. Such unevennesses are made small for the surface of the shaped object 100 that occur due to the expanded third thermal expansion material 43b included in the expanded third thermal expansion layer 41b located uppermost, thereby enabling achievement of high smoothness of the surface of the shaped object 100. Moreover, the expanded second thermal expansion layer 35b including the expanded second thermal expansion material of small average particle size buries the large unevennesses of the surface of the expanded first thermal expansion layer 31b, and the expanded third thermal expansion layer 41b including the expanded third thermal expansion material 43b of smallest average particle size buries the unevennesses of the surface of the expanded second thermal expansion layer 35b, thereby enabling achievement of higher smoothness of the surface of the shaped object 100. Further, the unevennesses of the expanded third thermal expansion layer 41b include (i) the protrusions including the expanded third thermal expansion material 43b and (ii) the recesses including the third thermal expansion material 43a.

As described above, the average particle size of the expanded third thermal expansion material 43b included in the expanded third thermal expansion layer 41b that is located uppermost (post-expansion average particle size of the third thermal expansion material 43a) is smallest, thereby enabling achievement of high smoothness of the surface of the shaped object 100. Furthermore, the post-expansion average particle size of the thermal expansion material becomes smaller in order from the base 20 side, and the unevennesses of the thermal expansion layer are buried in order from the base 20 side, thereby enabling achievement of higher smoothness of the surface of the shaped object 100.

### Modified Example

Although embodiments of the present disclosure are described above, various types of modifications of the present disclosure are possible within a scope that does not deviate from the gist of the present disclosure.

For example, the shaped object 100 may be manufactured in a roll-like shape from a roll-like formation sheet 10. Moreover, the material included in the base 20 is not limited to a thermoplastic resin and may be paper, cloth, or the like. The thermoplastic resin included in the base 20 is not limited to polyolefin resins and polyester resins. The thermoplastic resin included in the base 20 may be a polyamide resin, a polyvinyl chloride (PVC) resin, a polyimide resin, or the like.

In the formation sheet 10, the number n of the thermal expansion layers stacked on the first main surface 22 of the base 20 is not limited to two or three, and may be any plural number, that is, n may be any integer greater than or equal to two. That is, in the formation sheet 10, n thermal expansion layers (n is an integer greater than or equal to two) may be provided which are stacked on the first main surface 22 of the base 20. Furthermore, for the post-expansion average particle sizes of the thermal expansion materials included in each of the n thermal expansion layers, the post-expansion average particle size of the thermal expansion material included in the n-th thermal expansion layer from the base 20 that is the uppermost layer being smallest is sufficient. For example, in the formation sheet 10 equipped with three thermal expansion layers, the post-expansion average particle size of the thermal expansion material included in the first thermal expansion layer from the base 20 being smaller than the post-expansion average particle size of the thermal expansion material included in the second thermal expansion layer from the base 20 is sufficient; and the post-expansion average particle size of the thermal expansion material included in the third thermal expansion layer from the base 20 being smaller than the post-expansion average particle size of the thermal expansion material included in the first thermal expansion layer from the base 20 is sufficient.

By setting the characteristics of the binder and the thermal expansion material included in each of the n thermal expansion layers, the post-expansion average particle size of the thermal expansion material included in the n-th thermal expansion layer from the base 20 can be made smallest. For example, in Embodiment 1, the first binder 32 and the second binder 36 include the same material, the pre-expansion average particle size of the second thermal expansion material 37a is smaller than the pre-expansion average particle size of the first thermal expansion material 33a, and the expansion rate of the second thermal expansion material 37a and the expansion rate of the first thermal expansion material 33a are set equal to each other. Due to such configuration, the post-expansion average particle size of the second thermal expansion material 37a can be made smallest. Moreover, in Embodiment 1, the first binder 32 and the second binder 36 include the same material, the pre-expansion average particle size of the second thermal expansion material 37a is made equal to the pre-expansion average particle size of the first thermal expansion material 33a, and the expansion rate of the second thermal expansion material 37a is set smaller than the expansion rate of the first thermal expansion material 33a. Such configuration enables making the post-expansion average particle size of the second thermal expansion material 37a smallest. Furthermore, in Embodiment 1, the first thermal expansion material 33a and the second thermal expansion material 37a are taken to be the same thermally expandable microcapsules, and the first binder 32 includes a material that is more flexible than that of the second binder 36. Such configuration enables the post-expansion average particle size of the second thermal expansion material 37a to be made smallest.

Moreover, in the formation sheet 10, the post-expansion average particle size of the thermal expansion material contained in each of the n thermal expansion layers preferably is smaller in order from the base 20 side, that is, from the first thermal expansion layer. That is, the post-expansion average particle size of the thermal expansion material included in the m-th thermal expansion layer from the base 20, in which m is an integer greater than or equal to two and less than or equal to n, is preferably smaller than the post-expansion average particle size of the thermal expansion material included in the (m−1)-th thermal expansion layer from the base 20.

Furthermore, the shaped object 100 may be equipped with n expanded thermal expansion layers (n is an integer greater than or equal to two) on the first main surface 22 of the base 20. For the average particle sizes of the expanded thermal expansion material included in each of the n expanded thermal expansion layers, an average particle size of the expanded thermal expansion material included in the n-th expanded thermal expansion layer from the base 20 being smallest is sufficient.

Although the thermal conversion layers 130 of Embodiment 1 and 2 are stacked on the second main surface 24 of the base 20, the thermal conversion layer 130 may be stacked on the uppermost thermal conversion layer, that is, on the second thermal expansion layer 35a or the third thermal expansion layer 41a. Further, the thermal conversion layer 130 may be stacked on a release layer arranged on the second main surface 24 of the base 20 or on the uppermost thermal conversion layer. Due to such configuration, the thermal conversion layer 130 can be readily removed from the shaped object 100.

A layer of another, layers made of freely-selected material may be formed between the various layers of the formation sheet 10 and the shaped object 100. For example, an adhesive layer for further adhesion between the base 20 and the first thermal expansion layer 31a may be formed between the base 20 and the first thermal expansion layer 31a of the formation sheet 10. The adhesive layer, for example, may include a surface modifier.

Moreover, a color image may be printed on the formation sheet 10 and the shaped object 100. For example, a color ink layer, representing a color image and including four colors of ink that are cyan C, magenta M, yellow Y, and black K, may be stacked on the second thermal expansion layer 35a of the formation sheet 10 of Embodiment 1.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. A formation sheet comprising:
a base; and
n thermal expansion layers that each include a binder and a thermal expansion material that expands due to heat, the thermal expansion layers being stacked on a first main surface of the base, n being an integer greater than or equal to two, wherein
among post-expansion average particle sizes of the thermal expansion material included in each of the n thermal expansion layers, a post-expansion average particle size of the thermal expansion material included in an n-th thermal expansion layer is smallest.

2. The formation sheet according to claim 1, wherein
characteristics of the binder and the thermal expansion material included in each of the n thermal expansion layers are set such that, upon expansion of the n thermal expansion layers, the post-expansion average particle size of the thermal expansion material included in the n-th thermal expansion layer is smallest.

3. The formation sheet according to claim 1, wherein a post-expansion average particle size of the thermal expansion material included in an m-th thermal expansion layer is smaller than a post-expansion average particle size of the thermal expansion material included in an (m−1)-th thermal expansion layer, m being greater than or equal to two and less than or equal to n.

4. The formation sheet according to claim 1, wherein among pre-expansion average particle sizes of the thermal expansion material included in each of the n thermal expansion layers, a pre-expansion average particle size of the thermal expansion material included in the n-th thermal expansion layer is smallest.

5. The formation sheet according to claim 4, wherein the pre-expansion average particle size of the thermal expansion material is 5 μm to 50 μm.

6. The formation sheet according to claim 1, wherein a thickness of the n-th thermal expansion layer is less than thicknesses of each of the other thermal expansion layers.

7. A manufacturing method of a formation sheet, comprising:
a first layer stacking step of stacking, on a first main surface of a base, an (n−1)-th thermal expansion layer among n thermal expansion layers stacked on the first main surface of the base, the n thermal expansion layers that each include a binder and a thermal expansion material that expands due to heat, n being an integer greater than or equal to two; and
a second layer stacking step of stacking an n-th thermal expansion layer on the (n−1)-th thermal expansion layer, wherein
among post-expansion average particle sizes of the thermal expansion material included in each of the n thermal expansion layers, a post-expansion average particle size of the thermal expansion material included in the n-th thermal expansion layer is smallest.

8. A shaped object comprising:
a base; and
n expanded thermal expansion layers that each include a binder and an expanded thermal expansion material, the expanded thermal expansion layers being stacked on a first main surface of the base, n being an integer greater than or equal to two, the expanded thermal expansion layers that each have unevennesses on a surface opposing the base, wherein
among average particle sizes of the expanded thermal material included in each of the n expanded thermal expansion layers, an average particle size of the expanded thermal expansion material included in an n-th expanded thermal expansion layer is smallest.
